(19) United States
(12) Patent Application Publication
(10) Pub. No.: US 2013/0113590 A1
(43) Pub. Date: May 9, 2013

(54) INDUCTIVE COMPONENT AND MANUFACTURING METHOD THEREOF

(71) Applicants: WEI-CHIH YU, TAIPEI (TW); CHIA-YI WANG, TAIPEI (TW)

(72) Inventors: WEI-CHIH YU, TAIPEI (TW); CHIA-YI WANG, TAIPEI (TW)

(73) Assignees: LITE-ON TECHNOLOGY CORP., TAIPEI (TW); SILITEK ELECTRONIC (GUANGZHOU) CO., LTD., GUANGZHOU (CN)

(21) Appl. No.: 13/454,328

(22) Filed: Apr. 24, 2012

(30) Foreign Application Priority Data
Nov. 4, 2011 (CN) 201110351083.5

(51) Int. Cl. H01F 27/29; H01F 41/08

(52) U.S. Cl. 336/192; 29/605

(57) ABSTRACT

An inductive component includes: a ferromagnetic core; a coil made of aluminum and having a winding portion wound around the ferromagnetic core for a predetermined number of turns, and two extending portions extending respectively from two ends of the winding portion; and two terminals made of copper. Each terminal wraps around a respective one of the extending portions.

### CROSS-REFERENCE TO RELATED APPLICATION

This application claims priority to Chinese Application No. 201110351083.5, filed on Nov. 4, 2011.

### BACKGROUND OF THE INVENTION

1. Field of the Invention

The invention relates to an inductive component, and more particularly to a coil-type inductive component.

2. Description of the Related Art

A common coil-type inductive component comprises a core and a coil wound on the core. The core is generally made of a ferromagnetic material, but it can also be an air core. The coil is an enamel wire, which usually is a copper wire coated with insulating enamel on a surface thereof. Therefore, rising cost of copper results in a higher cost of the inductive component.

An aluminum wire may also be coated with insulating enamel to form an enamel wire suitable for use as the coil of the coil-type inductive component. The coil of the inductive component may require connection to a printed circuit board (PCB) by soldering. However, bonding between the aluminum wire and a solder is poor, and the surface of the aluminum wire is easily oxidized, so that it is difficult for the solder to completely wrap around the aluminum wire, thereby resulting in defective soldering, and poor connection between the inductive component and the PCB.

### SUMMARY OF THE INVENTION

Therefore, an object of the present invention is to provide an inductive component that is able to reduce cost and bind effectively with a solder.

According to one aspect of the present invention, an inductive component comprises:

a ferromagnetic core;

a coil made of aluminum and having a winding portion wound around the ferromagnetic core for a predetermined number of turns, and two extending portions extending respectively from two ends of the winding portion; and

two terminals made of copper, each wrapping around a respective one of the extending portions.

According to another aspect of the present invention, a method of manufacturing an inductive component comprises:

a) winding an aluminum wire around a ferromagnetic core to forma coil having a winding portion wound around the ferromagnetic core for a predetermined number of turns, and two extending portions extending respectively from two ends of the winding portion; and

b) wrapping each of the extending portions with a respective terminal made of copper.

### BRIEF DESCRIPTION OF THE DRAWINGS

Other features and advantages of the present invention will become apparent in the following detailed description of the preferred embodiments with reference to the accompanying drawings, of which:

FIG. 1 is a front view showing a ferromagnetic core, a coil and a terminal of a first preferred embodiment of the inductive component according to the present invention;

FIG. 2 is a flow chart of a manufacturing method of the first preferred embodiment;

FIG. 3 is a front view showing the terminal of the first preferred embodiment before wrapping around an extending portion of the coil;

FIG. 4 is a front view showing the terminal of the first preferred embodiment with a feeding strip;

FIG. 5 is a perspective view of the terminal of the first preferred embodiment;

FIG. 6 is a sectional view showing the extending portion of the coil and a soldering portion of the terminal before a bending operation;

FIG. 7 is a sectional view showing the extending portion of the coil and the soldering portion of the terminal after the bending operation;

FIG. 8 illustrates an assembly of the ferromagnetic core, the coil and the terminal before mounting on a plate member;

FIG. 9 illustrates the assembly of the ferromagnetic core, the coil and the terminal after mounting on the plate member;

FIG. 10 illustrates an insulator body filling a space between the ferromagnetic core and the plate member to form the first preferred embodiment of the inductive component;

FIG. 11 is a side view showing the inductive component according to the present invention;

FIG. 12 is a front view showing the terminal of a second preferred embodiment with a feeding strip;

FIG. 13 is a perspective view of the terminal of the second preferred embodiment;

FIG. 14 is a front view showing a relationship between the extending portion of the coil and the terminal of the second preferred embodiment; and

FIG. 15 is a partly sectional view showing an inductive component of the second preferred embodiment.

### DETAILED DESCRIPTION OF THE PREFERRED EMBODIMENTS

Before the present invention is described in greater detail with reference to the preferred embodiments, it should be noted herein that similar components are denoted by the same reference numerals in the following description.

The method according to the present invention is to manufacture a coil-type inductive component that is adapted to be connected to a printed circuit board (PCB). The inductive component may be made of an arbitrary-shaped ferromagnetic core wound with a coil made of aluminum, such as a square ferromagnetic core used in a transformer. In the preferred embodiments, a toroidal ferromagnetic core wound with a coil made of aluminum is taken as an example.

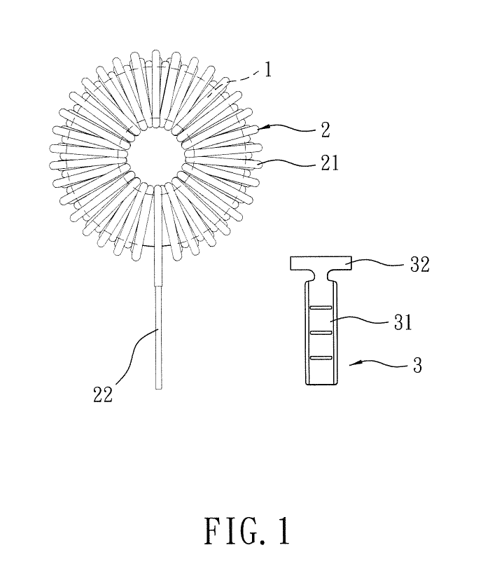

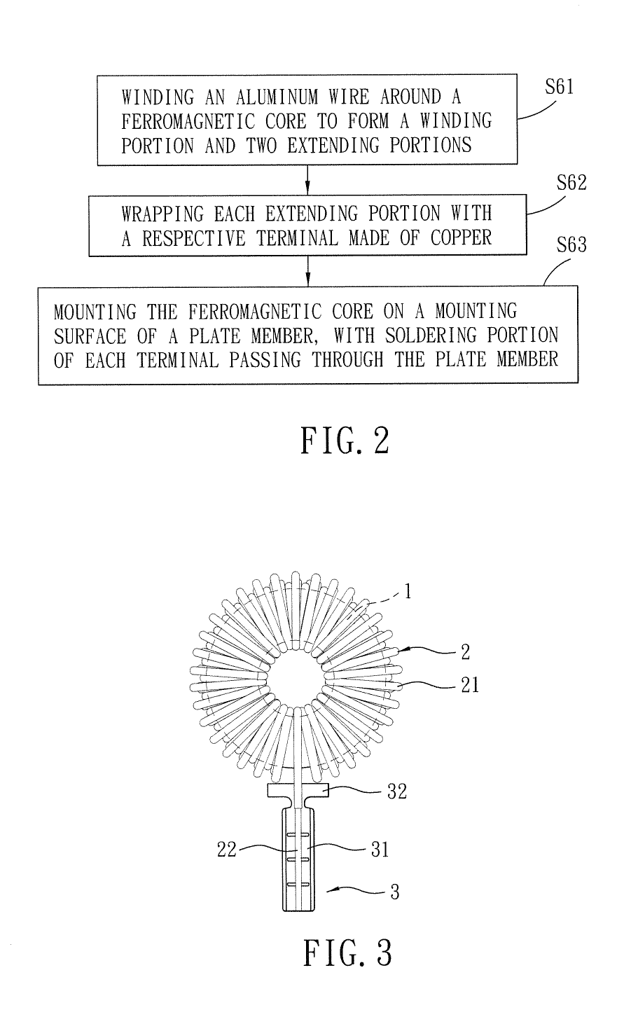

Referring to FIG. 1 and FIG. 2, the first preferred embodiment of the method of manufacturing an inductive component according to this invention comprises the following steps.

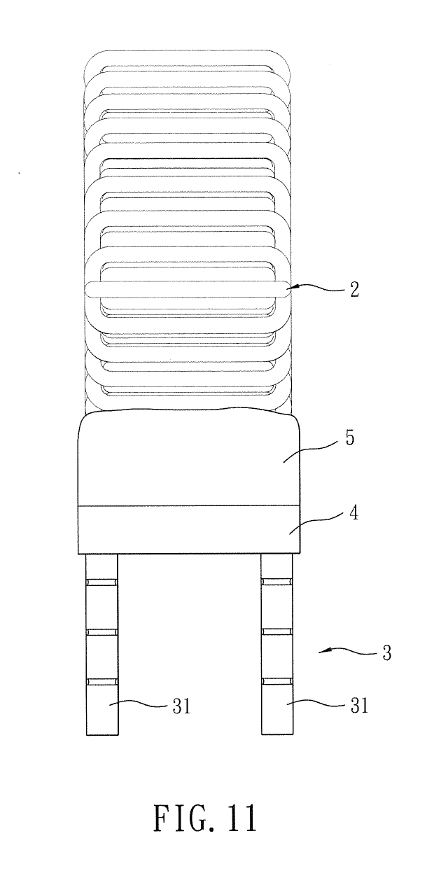

In step S61, an aluminum wire is wound around a ferromagnetic core 1 to form a coil having a winding portion 21 wound around the ferromagnetic core 1 for a predetermined number of turns, and two extending portions 22 extending respectively from two ends of the winding portion 21 (only one extending portion 22 is shown in FIG. 1 since positions of the two extending portions 22 overlap when viewed from the front; however, reference can be made to FIG. 11, which is a side view of the inductive component). The winding portion 21 is coated with an insulation layer, and the extending portions 22 are exposed from the insulation layer.

Subsequently, in step S62 with reference to FIG. 3, each of the extending portions 22 is wrapped with a respective terminal 3 made of copper.

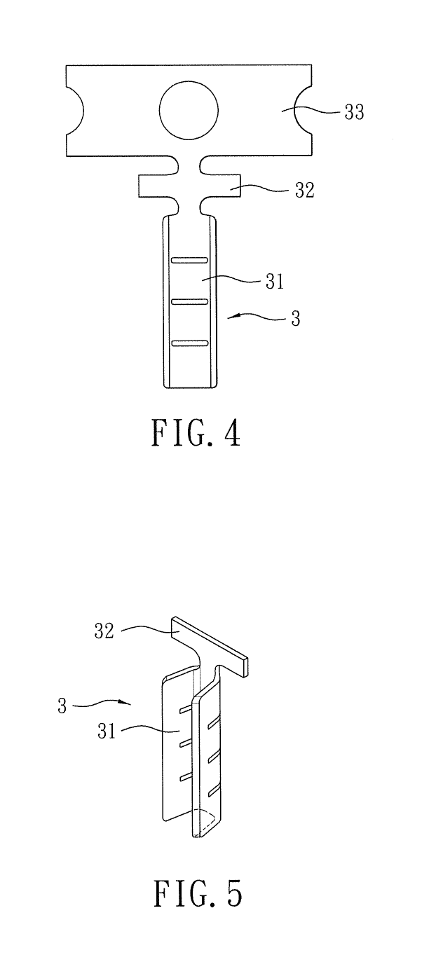

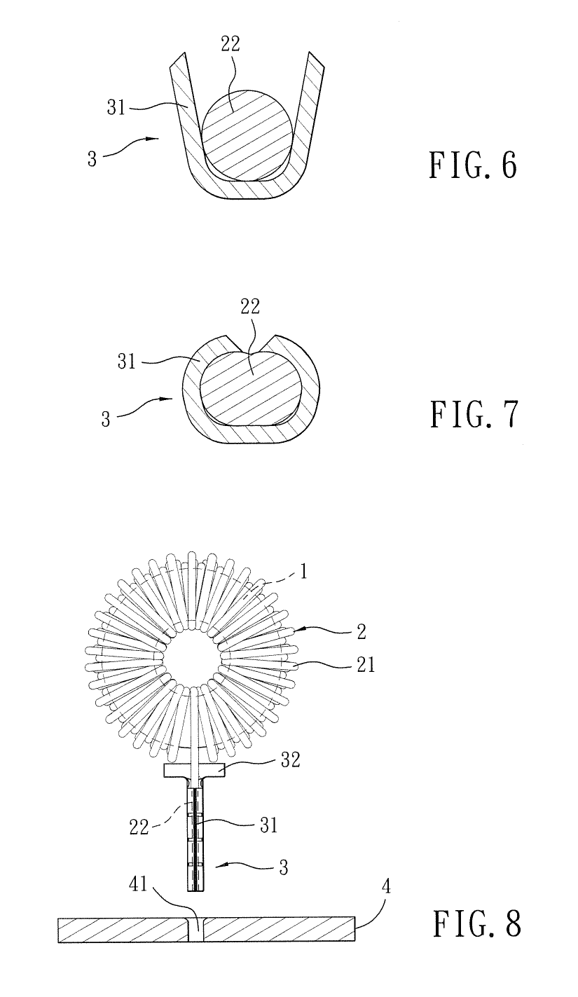

In detail, as shown in FIG. 4, the terminals 3 are mass produced by mechanical stamping a copper sheet. When stamping, two adjacent copper pieces are connected by a feeding strip 33 to facilitate mass production. The terminals 3 are formed by bending the copper pieces. Referring to FIG. 5, each terminal 3 has a soldering portion 31, and an abutting portion 32 formed on one end of the soldering portion 31. Prior to bending, the soldering portion 31 defines a groove, and a cross section of the soldering portion 31 is U-shaped. The soldering portion 31 thus has an opening for disposing a corresponding one of the extending portions 22 therein. Referring to FIG. 6, each extending portion 22 is disposed in the groove of the respective soldering portion 31 before the latter undergoes bending. The soldering portion 31 is formed by bending into a surrounding body part that wraps around the extending portion 22, as shown in FIG. 7. By virtue of the feeding strip 33, a plurality of terminals 3 may be positioned in an apparatus, and the extending portions 22 may be respectively disposed in the corresponding one of the terminals 3, so that wrapping of each of the extending portions 22 with a respective terminal 3 made of copper may be performed automatically. The feeding strip 33 is only shown in FIG. 4, and is omitted in the other figures to facilitate explanation.

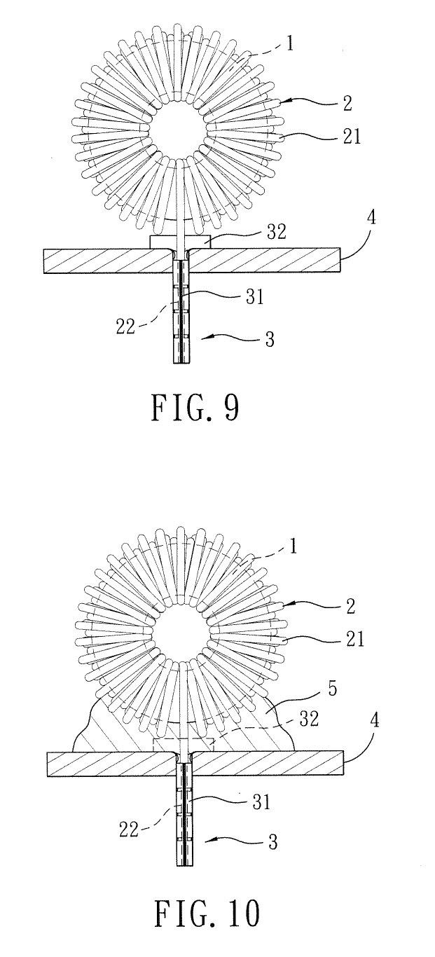

Thereafter, in step S63 and with reference to FIG. 8 and FIG. 9, the ferromagnetic core 1 is mounted on a mounting surface of a plate member 4 in a manner that the soldering portion 31 of each of the terminals 3 passes through a corresponding hole 41 in the plate member 4, and the abutting portion 32 abuts against the mounting surface of the plate member 4, thereby enhancing vibration resistance of the soldering portion 31.

Finally, as shown in FIG. 10 and FIG. 11, a space between the ferromagnetic core 1 and the plate member 4 is filled with an insulator body 5, such as an epoxy resin, so as to fix the ferromagnetic core 1 and the two extending portions 22 on the plate member 4 firmly, thereby completing manufacture of the inductive component of this preferred embodiment.

The inductive component of this embodiment can be superimposed on the PCB via the plate member 4, and isolates the extending portions 22 of the coil 2 made of aluminum from ambient air through the soldering portions 31 of the terminals 3 made of copper, so as to avoid oxidation of the extending portions 22, and to ensure conduction between the terminals 3 and the extending portions 22. Due to good bonding between copper and a solder, the coil 2, which is made of aluminum, may be effectively coupled to the PCB through the terminals 3, which are made of copper.

In this preferred embodiment, the coil 2 is made of aluminum and saves 75% of material cost compared to that made of copper. Further adding the cost of producing the terminals 3, which are made of copper, a single inductive component of this embodiment saves 20% of material cost compared to that using a copper coil. In mass production, the method of manufacturing an inductive component of this embodiment thus permits substantial reduction in material cost and can increase market competitiveness.

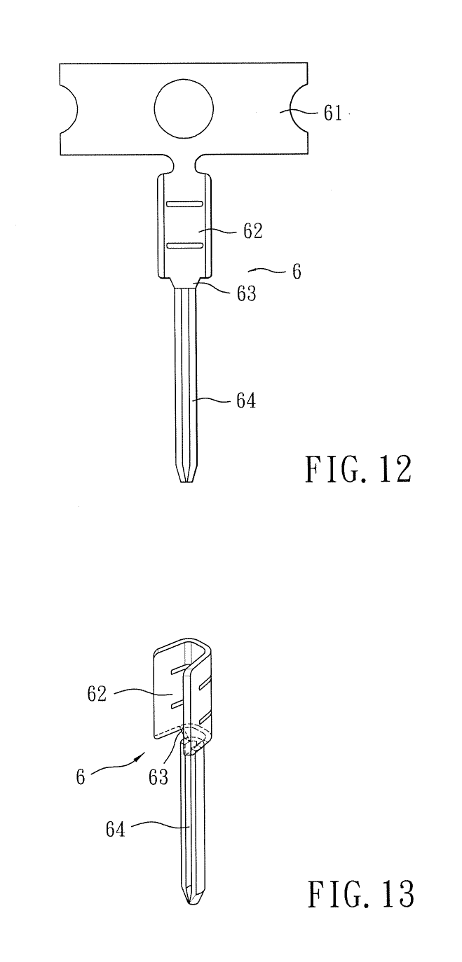

FIG. 12 and FIG. 13 show a second preferred embodiment of the inductive component according to the present invention. In this embodiment, the inductive component uses terminals 6 which are different from those of the first preferred embodiment. Compared to the terminal 3 shown in FIG. 4, the terminal 6 omits the abutting portion 32, and has a different form of the soldering portion 31, but it is also mass produced by mechanical stamping a copper sheet to form copper pieces, from which the terminals 6 are subsequently formed by bending. FIG. 12 shows two adjacent copper pieces 6 connected by a feeding strip 61 to facilitate mass production.

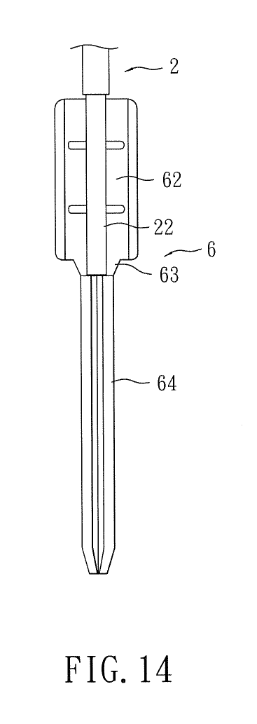

As shown in FIG. 13 and FIG. 14, each terminal 6 is made of copper and has a soldering portion 64, a wrapping portion 62 disposed at one end of the soldering portion 6 and with a width greater than that of the soldering portion 64, and a shoulder portion 63 that is disposed between the wrapping portion 62 and the soldering portion 64 and that has a width that is gradually reduced from the wrapping portion 62 to the soldering portion 64. The wrapping portion 62 and the soldering portion 64 of the terminal 6 are formed by bending a copper piece. Prior to bending, the wrapping portion 62 defines a groove, and a cross section of the wrapping portion 62 is U-shaped. The wrapping portion 62 thus has an opening for disposing a corresponding one of the extending portions 22 therein. The soldering portion 64 is formed into a column part, whose cross section is V-shaped. After disposing each extending portion 22 in the groove of the corresponding wrapping portion 62, the wrapping portion 62 is bent and formed into a surrounding body part in order to wrap around the respective extending portion 22.

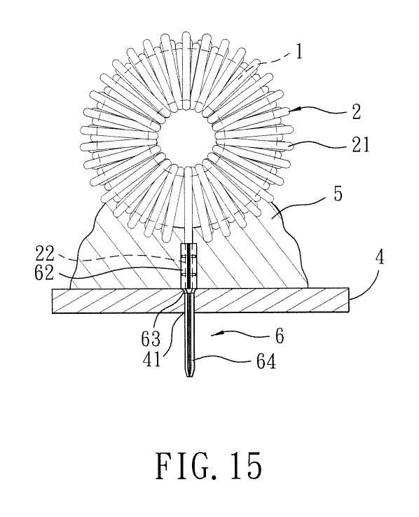

As shown in FIG. 15, each soldering portion 64 passes through the corresponding hole 41 in the plate member 4. Due to the wrapping portion 62 having a width greater than that of the soldering portion 64, the wrapping portion 62 abuts against a mounting surface of the plate member 4, and the shoulder portion 63 is seated on a bevel hole-defining wall segment of the hole 41 in the plate member 4. Finally, a space between the ferromagnetic core 1 and the plate member 4 is filled with an insulator body 5, such as an epoxy resin, so as to fix the ferromagnetic core 1 and the two extending portions 22 on the plate member 4 firmly, thereby completing manufacture of the inductive component of this preferred embodiment.

It should be readily appreciated by those skilled in the art that the cross section of the soldering portion 64 is not limited to a V-shape, and may be a U-shape, a hollow column, or a solid column in other embodiments of this invention.

It should be noted that, by inspecting direct current resistance (DCR) of the inductive component, reliability thereof could be proven. DCR measured from the extending portions 22 of the coil 2 of the second preferred embodiment is 171.8 mΩ, while DCR measured from the soldering portions 64 of the terminal 6 is 178.4 mΩ. Since increase in DCR attributed to addition of the terminal 6 is small, it is proven that the terminal 6 wrapping around the extending portion 22 of the coil 2 forms an effective electrical connection.

Referring to FIG. 10 and FIG. 15, manufacturing the inductive component and soldering the soldering portions 31, 64 onto the PCB may be done by an apparatus (such as a terminal bonding machine) consecutively performing clamping, positioning, and solder reflow to complete processes of wrapping each extending portion 22 with the terminal 3, 6, passing the soldering portion 31, 64 of each terminal 3, 6 through the corresponding hole 41 in the plate member 4, precisely superimposing the plate member 4 on the PCB, and soldering the soldering portion 31, 64 onto the PCB.

To sum up, the method of manufacturing the inductive component of this invention involves using two terminals 3, 6, which are made of copper, to wrap around two extending portions 22 of a coil 2, which is made of aluminum, whereby superior bonding between copper and a solder enables the solder to completely wrap around the soldering portions 31, 64 when soldering the terminals 3, 6 on the PCB, so as to ensure good conduction and reduce of manufacturing costs.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An inductive component comprising:
a ferromagnetic core;
a coil made of aluminum and having a winding portion wound around said ferromagnetic core for a predetermined number of turns, and two extending portions extending respectively from two ends of said winding portion; and
two terminals made of copper, each wrapping around a respective one of said extending portions.

2. The inductive component as claimed in claim 1, further comprising a plate member having said ferromagnetic core disposed thereon and having said terminals abutting thereagainst and passing therethrough.

3. The inductive component as claimed in claim 2, wherein said plate member has a mounting surface, said ferromagnetic core being mounted on said mounting surface, each of said terminals having a soldering portion passing through said plate member, and an abutting portion formed on one end of said soldering portion and abutting against said mounting surface of said plate member.

4. inductive component as claimed in claim 3, wherein said soldering portion of each of said terminals is formed by bending a copper piece into a surrounding body part that wraps around the respective one of said extending portions.

5. The inductive component as claimed in claim 2, wherein said plate member has a mounting surface, said ferromagnetic core being mounted on said mounting surface, each of said terminals having a soldering portion passing through said plate member, and a wrapping portion disposed at one end of said soldering portion and disposed on said mounting surface, said wrapping portion wrapping around the respective one of said extending portions.

6. The inductive component as claimed in claim 5, wherein said wrapping portion and said soldering portion of each of said terminals are formed by bending a copper piece, said wrapping portion being formed into a surrounding body part, said soldering portion being formed into a column part, said wrapping portion having a width greater than that of said soldering portion, each of said terminals further having a shoulder portion disposed between said wrapping portion and said soldering portion, said shoulder portion having a width that is gradually reduced from said wrapping portion to said soldering portion, said shoulder portion being disposed in said plate member.

7. inductive component as claimed in claim 2, further comprising an insulator body that fills a space between said ferromagnetic core and said plate member.

8. inductive component as claimed in claim 7, wherein said insulator body is made of epoxy resin.

9. The inductive component as claimed in claim 1, wherein said winding portion is coated with an insulation layer and said extending portions are exposed from said insulation layer.

10. A method of manufacturing an inductive component, comprising:
a) winding an aluminum wire around a ferromagnetic core to form a coil having a winding portion wound around the ferromagnetic core for a predetermined number of turns, and two extending portions extending respectively from two ends of the winding portion; and
b) wrapping each of the extending portions with a respective terminal made of copper.

11. method as claimed in claim 10, further comprising, after step b):
c) mounting the ferromagnetic core on a mounting surface of a plate member in a manner that a soldering portion of each of the terminals passes through the plate member.

12. The method as claimed in claim 11, wherein step b) includes bending two copper pieces into two surrounding body parts that serve as the soldering portions of the two terminals and that wrap around the extending portions, respectively.

13. The method as claimed in claim 12, wherein each of the copper pieces has a flange part that is formed on one end of the surrounding body part and that serves as an abutting portion for abutting against the mounting surface of the plate member in step c).

14. The method as claimed in claim 11, wherein step b) includes bending each of two copper pieces into the soldering portion and a wrapping portion of a respective one of the terminals, the wrapping portion being formed into a surrounding body part, the soldering portion being formed into a column part, the wrapping portion having a width greater than that of the soldering portion, a shoulder portion being formed between the wrapping portion and the soldering portion, the shoulder portion having a width that is gradually reduced from the wrapping portion to the soldering portion.

15. The method as claimed in claim 14, wherein:
in step b), each of the extending portions is wrapped with the wrapping portion of the respective one of the terminals; and
in step c), the wrapping portion of each of the terminals is disposed on the mounting surface of the plate member, and the shoulder portion of each of the terminals is disposed in the plate member.

16. The method as claimed in claim 11, further comprising, after step c):
d) filling a space between the ferromagnetic core and the plate member with an insulator body.

17. The method as claimed in claim 16, wherein the insulator body is made of epoxy resin.

18. The method as claimed in claim 10, wherein, in step a), the winding portion is coated with an insulation layer and the extending portions are exposed from the insulation layer.
